(19) United States
(12) Patent Application Publication
(10) Pub. No.: US 2010/0071060 A1
(43) Pub. Date: Mar. 18, 2010

(54) ELECTRONIC DEVICE AND METHOD FOR VERIFYING USER IDENTIFICATION

(75) Inventor: YU-WEI LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/496,656

(22) Filed: Jul. 2, 2009

(30) Foreign Application Priority Data
Sep. 16, 2008 (CN) 200810304517.4

(51) Int. Cl. H04L 9/32; G06F 21/00

(52) U.S. Cl. 726/19; 345/173; 715/863

(57) ABSTRACT

A method for verifying user identification receives an original symbol input by a user via a touch screen of an electronic device. A symbolic password is determined according to the original symbol. The method receives a login symbol input by the user via the touch screen and determines if the login symbol matches the symbolic password. The user is allowed to access the electronic device if the login symbol matches the symbolic password.

### BACKGROUND

1. Technical Field

Embodiments of the present disclosure relate to access control mechanisms, and particularly to an electronic device and method for verifying user identification.

2. Description of Related Art

User passwords are widely used to protect personal and private information in electronic devices, such as mobile phones and personal digital assistants. A user is required to input a user password before accessing data stored in an electronic device. However, most passwords consist of numbers and letters. The alphanumeric passwords are monotonous and somewhat hard to memorize.

### BRIEF DESCRIPTION OF THE DRAWINGS

FIG. 1 is a block diagram of one embodiment of a system for verifying user identification.

FIG. 2 is a flowchart of one embodiment of a method for verifying user identification.

FIG. 3 illustrates one embodiment of an original symbol and a first matrix.

FIG. 4 illustrates one embodiment of a second matrix derived from a first matrix.

FIG. 5 illustrates one embodiment of a login symbol and a third matrix.

FIG. 6 illustrates one embodiment of an offset between an original symbol and a login symbol.

### DETAILED DESCRIPTION

All of the processes described below may be embodied in, and fully automated via, functional code modules executed by one or more general purpose processors of an electronic device. The code modules may be stored in any type of storage medium. Some or all of the methods may alternatively be embodied in specialized hardware.

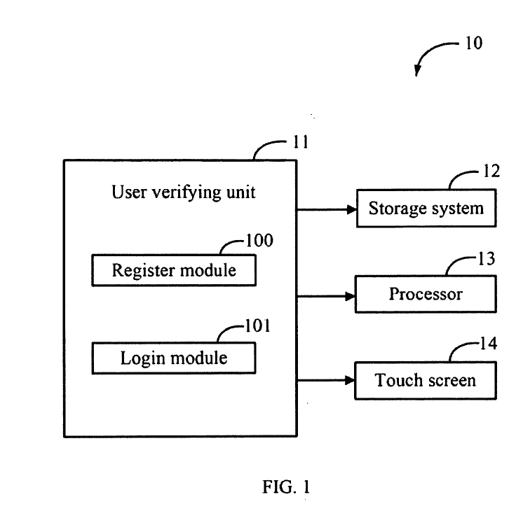

FIG. 1 is a block diagram of one embodiment of an electronic device 10 for verifying user identification. The electronic device 10 may be a mobile phone, a personal digital assistant (PDA), a handheld game player, or a digital camera.

In one embodiment, the electronic device 10 may include a user verifying unit 11, a storage system 12, a processor 13, and a touch screen 14. One or more computerized codes of the user verifying unit 11 is stored in the storage system 12 and executed by the processor 13. The user verifying unit 11 may be used to register a symbol as a symbolic password in the electronic device 10 and a user may then log into the electronic device 10 with the symbolic password via the touch screen 14. It may be understood that the symbol refers to a picture. The touch screen 14 may be a resistive touch screen, a capacitive touch screen, or any other suitable type of touch screen. It may be understood that the user may input a symbol to the electronic device 10 by drawing the symbol on the touch screen 14 with a touch pen or a finger. Each touch point is sensed by touch sensors of the touch screen 14. The storage system 12 may include an internal memory and an external memory. The external memory may include a smart media card (SMC), a secure digital card (SDC), a compact flash card (CFC), a multi media card (MMC), a memory system stick (MS), an extreme digital card (XDC), and a trans flash card (TFC).

In one embodiment, the user verifying unit 11 may include a register module 100 and a login module 101. The register module 100 is operable to receive an original symbol input by the user via the touch screen 14. The original symbol may consist of one or more curves that are drawn on the touch screen 14 by the user. The register module 100 is further operable to determine the symbolic password according to the original symbol, and store the symbolic password into the storage system 12.

In one embodiment, the register module 100 may generate a first matrix for the original symbol. The first matrix indicates a trace of the original symbol. The register module 100 may determine a second matrix to characterize the symbolic password based on the first matrix, and store the second matrix into the storage system 12.

The login module 101 is operable to receive a login symbol input by the user via the touch screen 14. Similarly, the login symbol may consist of one or more curves that are drawn on the touch screen 14 by the user. The login module 101 is further operable to compare the login symbol with the symbolic password, and determine if the login symbol matches the symbolic password stored in the storage system 12. If the login symbol matches the symbolic password, the login module 101 may allow the user to access the electronic device 10. Otherwise, if the login symbol does not match the symbolic password, the login module 101 may deny the user to access the electronic device 10.

In one embodiment, the login module 101 may generate a third matrix for the login symbol. The login module 101 may compare the third matrix with the second matrix, and determine if the third matrix matches the second matrix. If the third matrix matches the second matrix, the login module 101 may allow the user to access the electronic device 10. Otherwise, if the third matrix does not match the second matrix, the login module 101 may deny the user to access the electronic device 10.

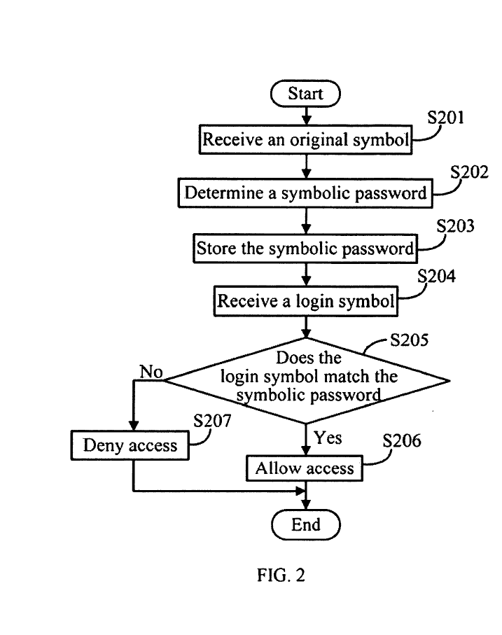

FIG. 2 is a flowchart of one embodiment of a method for verifying user identification in the electronic device 10 by implementing the user verifying unit 11 of FIG. 1. Depending on the embodiments, additional blocks may be added, others removed, and the ordering of the blocks may be changed.

In block S201, the register module 100 receives an original symbol input by the user via the touch screen 14. In one embodiment, the register module 100 may generate a register interface for the user to draw the register symbol on the touch screen 14. The register module 100 generates a first matrix for the original symbol.

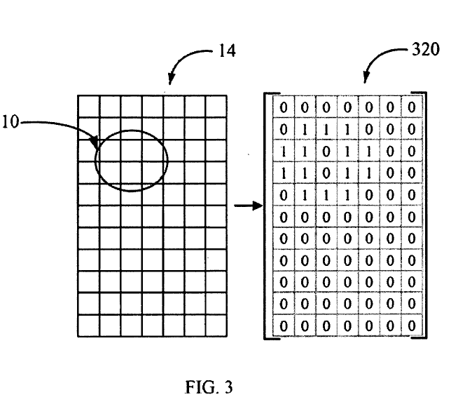

In one embodiment with respect to FIG. 3, the touch screen 14 is divided into 77 sections, each section includes at least one touch sensor. Each touch point on the touch screen 14 may be sensed by the touch sensors. A circle 310 denotes the original symbol. Correspondingly, the register module 100 generates a 7×11 matrix 320 for the circle 310. The 7×11 matrix 320 has 7 rows and 11 columns and includes 77 elements. Each element in the 7×11 matrix 320 corresponds to a specific section in the touch screen 14. The register module 100 assigns a value to each element in the 7×11 matrix 320. In the exemplary embodiment, the register module 100 assigns a value “1” to each element in the 7×11 matrix 320, if the element corresponds to a section of the touch screen 14 that includes one or more touch points. Otherwise, the register module 100 assigns a value “0” to each element in the 7×11 matrix 320, if the element corresponds to a section of the touch screen 14 that includes no touch points.

Depending on the embodiment, the register module 100 may confirm the original symbol. In this case, the user is prompted to redraw the original symbol on the touch screen 14. The register module 100 may generate another first matrix for the original symbol, and determine if a difference between the two first matrices is within a first predetermined tolerance. If the difference between the two first matrices is within the first predetermined tolerance, the procedure may go to block S202. Otherwise, if the difference between the two first matrices is greater than the first predetermined tolerance, the procedure may repeat the block S201.

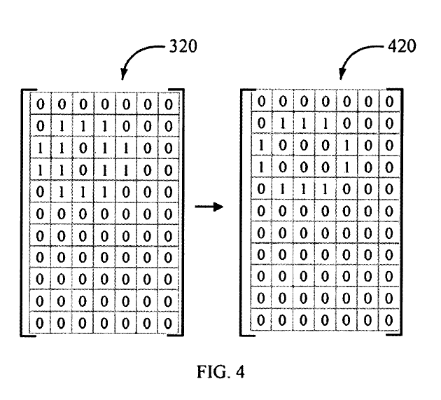

In block S202, the register module 100 determines a symbolic password according to the original symbol. In one embodiment, the register module 100 may determines a second matrix to characterize the symbolic password according to the first matrix/matrices. In one example with respect to FIG. 4, the register module 100 may determined a second matrix 420 according to the first matrix 320.

In block S203, the register module 100 stores the symbolic password into the storage system 12. In one example, the register module 100 stores the second matrix as the symbolic password into a compact flash card of the electronic device 10.

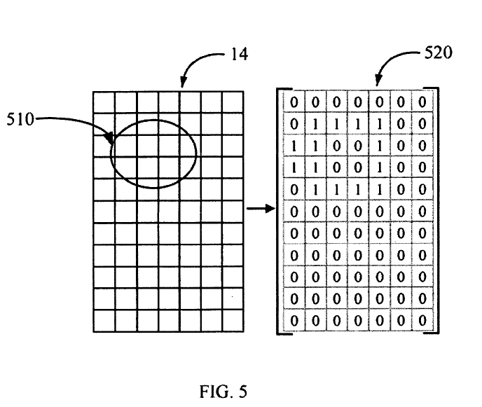

In block S204, the login module 101 receive a login symbol input by the user via the touch screen 14. The login module 101 may provide a login interface for the user to input the login symbol. Furthermore, the login module 101 may generate a third matrix for the login symbol. In one example with respect to FIG. 5, a circle 510 denotes the login symbol and a matrix 520 denotes the third matrix derived from the circle 510.

In block S205, the login module 101 compares the login symbol with the symbolic password stored in the storage system 12, and determines if the login symbol matches the symbolic password. In one embodiment, the login module 101 may calculate a difference between the third matrix and the second matrix, and determines if the difference is within a second predetermined tolerance.

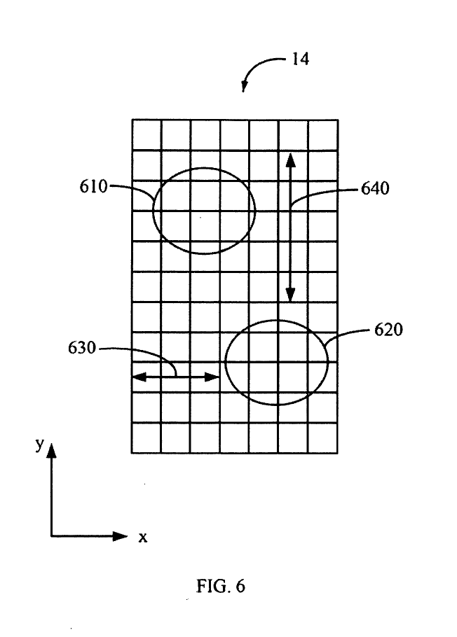

In one embodiment with respect to FIG. 6, a first circle 610 denotes the original symbol, a second circle 620 denotes the login symbol. There is an offset comprising an x-axis offset 630 and a y-axis offset 640 between the original symbol and the login symbol. The login module 101 may subtract the offset when calculating the difference between the original symbol and the login symbol.

If the login symbol matches the symbolic password, in block S206, the login module 101 may allow the user to access the electronic device 10.

Otherwise, if the login symbol does not match the symbolic password, in block S207, the login module 101 may deny the user to access the electronic device 10.

Depending on the embodiment, the login module 101 may allow the user to input the login symbol more than one time. For example, the register module 100 may allow the user to input the login symbol three times. Therefore, the procedure may return to block S204 if the login symbol does not match the symbolic password. As such, the user may log into the electronic device 10 using the symbolic password.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a touch screen;
a storage system;
at least one processor; and
a user verifying unit stored in the storage system and being executable by the at least one processor, the user verifying unit comprising:
a register module to receive an original symbol input by a user via the touch screen, determine a symbolic password according to the original symbol, and store the symbolic password into the storage system; and
a login module to receive a login symbol input by the user via the touch screen, determine if the login symbol matches the symbolic password stored in the storage system, and allow/deny the user to access the electronic device according to the determination.

2. The electronic device of claim 1, wherein the electronic device is selected from the group consisting of a mobile phone, a personal digital assistant (PDA), a handheld game player, and a digital camera.

3. The electronic device of claim 1, wherein the storage system is selected from the group consisting of a smart media card (SMC), a secure digital card (SDC), a compact flash card (CFC), a multi media card (MMC), a memory system stick (MS), an extreme digital card (XDC), and a trans flash card (TFC).

4. The electronic device of claim 1, wherein the touch screen is a resistive touch screen or a capacitive touch screen.

5. The electronic device of claim 1, wherein the register module generates one or more first matrices for the original symbol, and determines a second matrix to characterize the symbolic password according to the one or more first matrices.

6. The electronic device of claim 5, wherein the login module generates a third matrix for the login symbol, and compares the third matrix with the second matrix so as to determine if the login symbol matches the symbolic password.

7. A method for verifying user identification in an electronic device, the method comprising:
receiving an original symbol input by a user via a touch screen of the electronic device;
determining a symbolic password according to the original symbol;
storing the symbolic password into a storage system of the electronic device;
receive a login symbol input by the user via the touch screen;
determining if the login symbol matches the symbolic password stored in the storage system by comparing the login symbol with the symbolic password;
allow the user to access the electronic device in response to a determination that the login symbol matches the symbolic password; or
deny the user to access the electronic device in response to a determination that the login symbol does not match the symbolic password.

8. The method of claim 7, wherein the electronic device is selected from the group consisting of a mobile phone, a personal digital assistant (PDA), a handheld game player, and a digital camera.

9. The method of claim 7, wherein the storage system is selected from the group consisting of a smart media card (SMC), a secure digital card (SDC), a compact flash card (CFC), a multi media card (MMC), a memory system stick (MS), an extreme digital card (XDC), and a trans flash card (TFC).

10. The method of claim 7, wherein the touch screen is a resistive touch screen or a capacitive touch screen.

11. The method of claim 7, wherein the original symbol is characterized by a first matrix and the symbolic password is characterized by a second matrix according to the first matrix.

12. The method of claim 11, wherein the login symbol is characterized by a third matrix and the third matrix is compared with the second matrix so as to determine if the login symbol matches the symbolic password.

13. A storage medium having stored thereon instructions that, when executed by an electronic device, cause the electronic device to execute a method for verifying user identification, the method comprising:
generating a register interface for a user to input an original symbol via a touch screen of the electronic device;
determining a symbolic password according to the original symbol;
storing the symbolic password into a storage system of the electronic device;
generating a login interface for the user to input a login symbol via the touch screen;
determining if the login symbol matches the symbolic password stored in the storage system by comparing the login symbol with the symbolic password;
allow the user to access the electronic device in response to a determination that the login symbol matches the symbolic password; or
deny the user to access the electronic device in response to a determination that the login symbol does not match the symbolic password.

14. The medium of claim 13, wherein the electronic device is selected from the group consisting of a mobile phone, a personal digital assistant (PDA), a handheld game player, and a digital camera.

15. The medium of claim 13, wherein the storage system is selected from the group consisting of a smart media card (SMC), a secure digital card (SDC), a compact flash card (CFC), a multi media card (MMC), a memory system stick (MS), an extreme digital card (XDC), and a trans flash card (TFC).

16. The medium of claim 13, wherein the touch screen is a resistive touch screen or a capacitive touch screen.

17. The medium of claim 13, wherein the original symbol is characterized by a first matrix and the symbolic password is characterized by a second matrix according to the first matrix.

18. The medium of claim 17, wherein the login symbol is characterized by a third matrix, the third matrix is compared with the second matrix so as to determine if the login symbol matches the symbolic password.
